(19) United States
(12) Patent Application Publication
(10) Pub. No.: US 2026/0153602 A1
(43) Pub. Date: Jun. 4, 2026

(54) TRANSMIT-RECEIVE COAXIAL PHASED ARRAY LIDAR CHIP AND CONTROL METHOD

(71) Applicant: BEIJING RESEARCH INSTITUTE OF TELEMETRY, Beijing (CN)

(72) Inventor: Yaqi LIU, Beijing (CN)

(73) Assignee: BEIJING RESEARCH INSTITUTE OF TELEMETRY, Beijing (CN)

(21) Appl. No.: 19/457,623

(22) Filed: Jan. 23, 2026

Related U.S. Application Data
(63) Continuation-in-part of application No. PCT/CN2023/114212, filed on Aug. 22, 2023.

(30) Foreign Application Priority Data
Jul. 25, 2023 (CN) 202310922223.2

(51) Int. Cl. G01S 7/481; G01S 7/4865; G01S 7/4915; G01S 7/497; G01S 17/58; G01S 17/89; G01S 17/931

(52) U.S. Cl. CPC G01S 7/4817; G01S 7/4865; G01S 7/4915; G01S 7/497; G01S 17/58; G01S 17/89; G01S 17/931

(57) ABSTRACT

Disclosed is a transmit-receive coaxial phased array LiDAR chip and a control method. The transmit-receive coaxial phased array LiDAR chip includes a laser transmitter unit, a main beam splitter, a transmit-receive phased array, a balanced detector array, and a signal processing and control unit. Phase modulation is performed on optical signals, and the optical signals are split into reference light and signal light. The signal light is radiated into a free space. The reference light passes through a frequency shifter and is input into a 90-degree optical mixer with an echo signal to generate a beat signal. The balanced detector array receives the beat signal, converts the beat signal into an electrical signal, and transmits the electrical signal to the signal processing and control unit. The signal processing and control unit calculates three-dimensional depth information and/or velocity information of a target region based on the electrical signal.

### CROSS-REFERENCE TO RELATED APPLICATIONS

This application is a continuation-in-part of International Application No. PCT/CN2023/114212, filed on Aug. 22, 2023, which claims priority to Chinese Patent Application No. 202310922223.2, filed on Jul. 25, 2023, the entire contents of each of which are hereby incorporated by reference.

### TECHNICAL FIELD

The present disclosure generally relates to the field of electrical components, in particular, to a transmit-receive coaxial phased array LiDAR chip and a control method.

### BACKGROUND

A three-dimensional imaging light detection and ranging (LiDAR) system typically requires a large field of view to meet practical application requirements. The angle of the field of view of the three-dimensional imaging LiDAR system is related to the scanning range of an emitted laser beam. Similarly, a receiving system needs to have a field of view with a corresponding angle range to achieve matching between a transmitting field of view and a receiving field of view. However, a larger receiving field of view leads to more ambient background light and stray light, resulting in a lower signal-to-noise ratio of the LiDAR system.

In the prior art, the LiDAR system has a large blind spot, more stray light, and a low signal-to-noise ratio, which cannot meet the requirements of the three-dimensional imaging LiDAR system.

Therefore, a LiDAR system with a small blind spot, less stray light, and a high signal-to-noise ratio is needed.

### SUMMARY

One or more embodiments of the present disclosure provide a transmit-receive coaxial phased array LiDAR chip and a control method for the transmit-receive coaxial phased array LiDAR chip to solve problems in existing LiDAR systems, such as a large blind spot, more stray light, and low signal-to-noise ratio. The transmit-receive coaxial phased array LiDAR chip implements transmission and reception of optical signals simultaneously through a transmit-receive phased array. Since a transmitting optical axis coincides with a receiving optical axis, the transmit-receive coaxial phased array LiDAR chip can help reduce the blind spot of the LiDAR system. Using the transmit-receive phased array for reception in the LiDAR system is equivalent to using a receiving optical system with a flexibly steerable field of view, which avoids the problems of more stray light and low signal-to-noise ratio caused by using a static large field of view for reception to achieve matching between the transmitting and receiving fields of view. Meanwhile, the transmit-receive coaxial phased array LiDAR chip uses a 90-degree optical mixer combined with a balanced detector array to implement coherent detection, improving the signal-to-noise ratio. The transmit-receive coaxial phased array LiDR chip uses easily integrated means such as semiconductor devices and printed circuit boards (PCBs). The transmit-receive coaxial phased array LiDAR chip can leverage advantages of an optoelectronic integration process platform to achieve a monolithic LiDAR system with a high signal-to-noise ratio, high integration, and low cost.

One or more embodiments of the present disclosure provide a transmit-receive coaxial phased array LiDAR chip, including a laser transmitter unit, a main beam splitter, and a transmit-receive phased array which are optically connected in sequence, a balanced detector array optically connected to a receiving output port of the transmit-receive phased array, and a signal processing and control unit electrically connected to the laser transmitter unit, the transmit-receive phased array, and the balanced detector array.

The laser transmitter unit, under the control of the signal processing and control unit, generates an optical signal and outputs the optical signal to the main beam splitter. The main beam splitter splits the optical signal into N channels of optical signals and outputs the N channels of optical signals to the transmit-receive phased array, respectively. The transmit-receive phased array, under the control of the signal processing and control unit, performs phase modulation on the N channels of optical signals to output N channels of phase-modulated signal light and N channels of phase-modulated reference light. The N channels of phase-modulated signal light are projected to a detection region for scanning by the transmit-receive phased array. A scanning deflection angle is (θₓ₀, θ_{y0}). N is greater than 2. The transmit-receive phased array receives an echo signal reflected by a target in the detection region and performs coherent mixing on the echo signal with N channels of frequency-shifted reference light to generate a beat signal, and outputs the beat signal to the balanced detector array. A center direction of a receiving field of view of the transmit-receive phased array is (θₓ₀, θ_{y0}). The balanced detector array converts the beat signal carrying echo signal information into an electrical signal and outputs the electrical signal to the signal processing and control unit. The signal processing and control unit processes the electrical signal and calculates, based on a time difference between the optical signal output by the laser transmitter unit and the echo signal, at least one of three-dimensional depth information or velocity information of the target in the detection region.

One or more embodiments of the present disclosure provide a control method for a transmit-receive coaxial phased array LiDAR chip. The control method includes the following operations:

S1, starting operation of the transmit-receive coaxial phased array LiDAR chip, laser emission proceeding to operation S2, and echo signal reception and processing proceeding to operation S3.

S2, splitting an optical signal output by a laser transmitter unit into N channels of optical signals by a main beam splitter and transmitting the N channels of optical signals to a transmit-receive phased array, performing phase control on the N channels of optical signals by the transmit-receive phased array based on a control signal of a signal processing and control unit, and then splitting the N channels of optical signals to obtain N channels of phase-modulated reference light and N channels of phase-modulated signal light, performing frequency shifting on the N channels of phase-modulated reference light to obtain N channels of frequency-shifted reference light, and proceeding to the operation S3, radiating the N channels of phase-modulated signal light to a free space by the transmit-receive phased array, with an emission direction of (θₓ₀, θ_{y0}), and generating an echo signal and proceeding to the operation S3.

S3, receiving, by the transmit-receive phased array, the echo signal and performing coherent mixing on the echo signal with the N channels of frequency-shifted reference light to obtain a beat signal, and outputting the beat signal to a balanced detector array, a center of a receiving field of view of the transmit-receive phased array being (θₓ₀, θ_{y0}), converting, by the balanced detector array, the beat signal carrying echo signal information into an electrical signal and outputting the electrical signal to the signal processing and control unit, and parsing, by the signal processing and control unit, the electrical signal to obtain three-dimensional depth information of a target region, thereby completing the control method for the transmit-receive coaxial phased array LiDAR chip.

The present disclosure has the following advantages:

One or more embodiments of the present disclosure provide the transmit-receive coaxial phased array LiDAR chip. The transmit-receive coaxial phased array LiDAR chip implements transmission and reception of optical signals simultaneously through the transmit-receive phased array. Since a transmitting optical axis coincides with a receiving optical axis, the transmit-receive coaxial phased array LiDAR chip can help reduce the blind spot of the LiDAR system. Using the transmit-receive phased array for reception in the LiDAR system is equivalent to using a receiving optical system with a flexibly steerable field of view, which avoids the problems of more stray light and low signal-to-noise ratio caused by using a static large field of view for reception to achieve matching between the transmitting and receiving fields of view. Meanwhile, the transmit-receive coaxial phased array LiDAR chip uses the 90-degree optical mixer combined with the balanced detector array to implement coherent detection, improving the signal-to-noise ratio. The transmit-receive coaxial phased array LiDR chip uses easily integrated means such as semiconductor devices and printed circuit boards (PCBs). The transmit-receive coaxial phased array LiDAR chip can leverage advantages of an optoelectronic integration process platform to achieve a monolithic LiDAR system with a high signal-to-noise ratio, high integration, and low cost.

### BRIEF DESCRIPTION OF THE DRAWINGS

FIG. 1 is a schematic diagram illustrating an exemplary architecture of a transmit-receive coaxial phased array LiDAR chip according to some embodiments of the present disclosure;

FIG. 2 is a schematic diagram illustrating an exemplary structure of a single phased array element of a transmit-receive phased array according to some embodiments of the present disclosure;

FIG. 3 is a schematic diagram illustrating an exemplary arrangement of grating radiation antennas according to some embodiments of the present disclosure;

FIG. 4 is a flowchart diagram illustrating an exemplary control method for a transmit-receive coaxial phased array LiDAR chip according to some embodiments of the present disclosure;

FIG. 5 is a flowchart diagram illustrating an exemplary control method for a transmit-receive coaxial phased array LiDAR chip in Embodiment 3 according to some embodiments of the present disclosure.

### REFERENCE SIGNS IN THE FIGURES

1. laser transmitter unit; 2. main beam splitter; 3. transmit-receive phased array; 31. phase modulator; 32. 1×2 beam splitter; 33. circulator; 331. first port; 332. second port; 333. third port; 34. grating radiation antenna; 35. frequency shifter; 36. 90-degree optical mixer; 4. balanced detector array; 5. signal processing and control unit.

### DETAILED DESCRIPTION

The technical solutions in the embodiments of the present disclosure are described clearly and completely below with reference to the accompanying drawings in the embodiments of the present disclosure. Clearly, the embodiments described are only some but not all of the embodiments of the present disclosure.

In some embodiments, a transmit-receive coaxial phased array LiDAR chip includes:

A laser transmitter unit is configured to generate an optical signal.

A main beam splitter is connected to the laser transmitter unit and configured to split the optical signal generated by the laser transmitter unit into a plurality of channels.

A transmit-receive phased array is configured to split a single channel of optical signal into signal light and reference light, project the signal light to a detection region for scanning, receive an echo signal reflected by a target in the detection region, and perform coherent mixing on the echo signal and frequency-shifted reference light to generate a beat signal. The detection region refers to a region that needs to be detected and scanned. The signal light refers to a part of the optical signal that is emitted to the detection region. The signal light is reflected by the target to form the echo signal after being emitted. The reference light refers to a part of the optical signal that is retained in the LiDAR chip. The reference light is frequency-shifted to obtain the frequency-shifted reference light for performing coherent mixing with the echo signal to generate the beat signal. The beat signal refers to an optical signal obtained by superimposing two optical signals (e.g., the echo signal reflected by the target and the frequency-shifted reference light). A signal frequency of the beat signal is equal to a frequency difference between the two optical signals.

A balanced detector array is connected to the transmit-receive phased array and configured to convert the beat signal into an electrical signal.

A signal processing and control unit is configured to process the electrical signal and determine at least one of three-dimensional depth information or velocity information of the target in the detection region, and further configured to control laser emission and phase modulation of the laser transmitter unit and the transmit-receive phased array. The target refers to an object that needs to be tracked and monitored in the detection region.

The transmit-receive phased array further includes a plurality of identical phased array elements. Each of the plurality of phased array elements independently controls a single channel of optical signal. Each of the plurality of phased array elements includes a phase modulator, a 1×2 beam splitter, a circulator, a grating radiation antenna, a frequency shifter, and a 90-degree optical mixer. The phase modulator is configured to perform phase control on the optical signal in the phased array element according to a control signal of the signal processing and control unit. The 1×2 beam splitter is configured to split the optical signal into the reference light and the signal light. The circulator is configured to cause the signal light to enter from a first port of the circulator and exit from a second port of the circulator, and then the signal light is coupled into a free space by the grating radiation antenna. The circulator is further configured to cause the echo signal to enter from the second port and exit from a third port. The frequency shifter is configured to perform frequency shifting on the reference light. The 90-degree optical mixer is configured to perform coherent mixing on the echo signal received at the third port of the circulator and the reference light to generate the beat signal.

The laser transmitter unit may be a semiconductor laser chip or a fiber laser. A wavelength of the optical signal emitted by the laser transmitter unit is between a visible light band and a far-infrared band.

The optical signal emitted by the laser transmitter unit is a pulsed laser signal or a frequency-modulated continuous-wave laser signal. The pulsed laser signal may be used for a time-of-flight ranging manner, and the frequency-modulated continuous-wave laser signal may be used for a frequency-modulated continuous-wave ranging manner.

The main beam splitter, the transmit-receive phased array, and the balanced detector array may be semiconductor devices.

The transmit-receive phased array has N phased array elements, and N is greater than 2.

A splitting ratio of the main beam splitter is 1×N, where N is a count of elements in the phased array elements.

A count of array elements (i.e., balanced detectors) of the balanced detector array is N. The balanced detector array is configured to receive the beat signal generated by the superimposition of the reference light and the echo signal and convert the beat signal into the electrical signal. Each of the balanced detectors includes two balanced photodiodes, and each of the balanced detectors includes two inputs and one output.

The 1×2 beam splitter is configured to split the optical signal into the signal light and the reference light. A splitting ratio of the reference light to the signal light is in a range of 1:1-1:99.

A frequency shift magnitude of the frequency shifter is in a range of 1-100 MHz. The frequency shifter is configured to perform frequency modulation on the reference light to facilitate subsequent coherent mixing detection with the echo signal.

The 90-degree optical mixer may be a multimode interference coupler or may be composed of a directional coupler and a phase shifter. The 90-degree optical mixer is configured to mix the echo signal and the reference light to generate the beat signal.

The grating radiation antennas in the transmit-receive phased array are arranged in a one-dimensional or two-dimensional periodic manner, or the grating radiation antennas are arranged in a sparse arrangement manner. The grating radiation antennas are configured to implement one-dimensional or two-dimensional light scanning in a far field. Counts of the grating radiation antennas in x and y directions are n1 and n2, respectively, and n1×n2=N. When the grating radiation antennas are arranged with a period Tᵢ, a relationship between a scanning angle range θᵢ(i=x, y) in x, y directions of the grating radiation antennas and the period Tᵢ of the grating radiation antennas is as follows:

$${θ}_{i} = \pm {sin}^{- 1} \frac{λ}{2 {T}_{i}}$$

where λ is a wavelength of the optical signal emitted by the laser transmitter unit.

The signal processing and control unit may be a PCB or another integrated system. The signal processing and control unit includes an amplifier, a filter, a processor, or the like. The signal processing and control unit is configured to send control information to the laser transmitter unit and the phase modulator, and determine at least one of distance information or velocity information of the target relative to the LiDAR chip based on a feedback electrical signal.

The technical solution includes: the laser transmitter unit, the main beam splitter, the transmit-receive phased array, the balanced detector array, and the signal processing and control unit. The transmit-receive phased array includes the plurality of phased array elements. Each of the plurality of phased array elements includes the phase modulator, the 1×2 beam splitter, the circulator, the grating radiation antenna, the frequency shifter, and the 90-degree optical mixer. The phase modulator is connected to respective output optical path of the main beam splitter. After performing phase modulation on the optical signal output by the main beam splitter, the phase modulator outputs the optical signal to the 1×2 beam splitter. The 1×2 beam splitter splits the optical signal into the reference light and the signal light. The signal light enters from the first port of the circulator and exits from the second port of the circulator, and then the signal light is coupled into free space by the grating radiation antenna. After passing through the frequency shifter, the reference light is combined with the echo signal returned from the third port of the circulator and input to the 90-degree optical mixer to generate the beat signal. The beat signal is then received by the balanced detector and converted into the electrical signal. The electrical signal is transmitted to the signal processing and control unit. The signal processing and control unit determines at least one of the three-dimensional depth information or the velocity information of the target region based on the electrical signal. The present disclosure implements chip integration of the transmitting end and the detecting end of the LiDAR system through the transmit-receive coaxial phased array LiDAR chip and coherent detection. Compared with the conventional LiDAR systems, the signal-to-noise ratio and the integration level of the transmit-receive coaxial phased array LiDAR chip are higher. The target region refers to a region within the detection region that is scanned by the optical signal of the LiDAR system and generates the echo signal.

### Embodiment 1

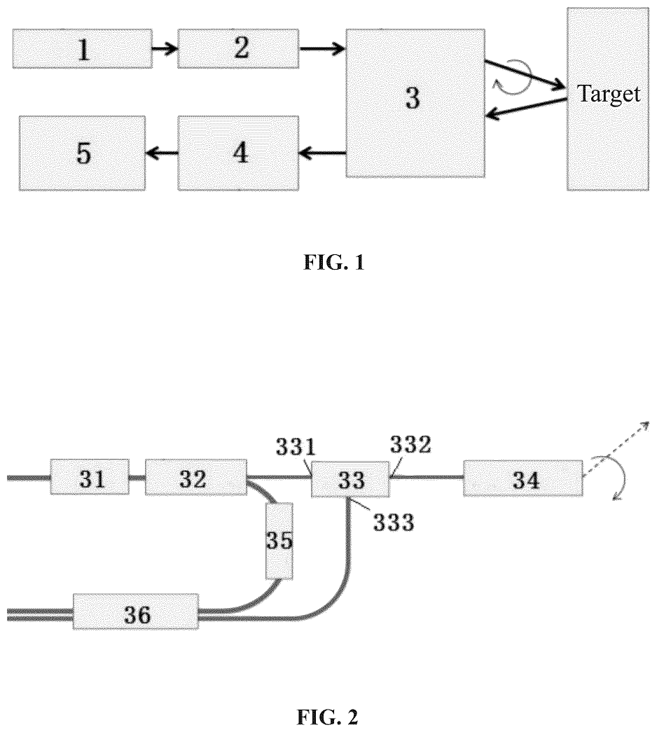

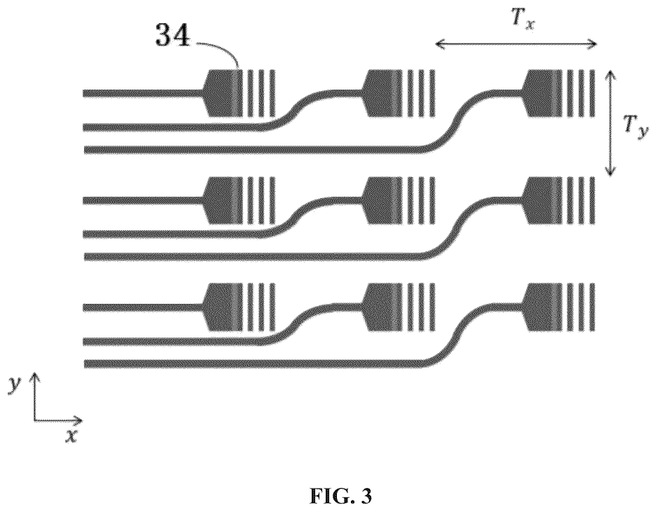

FIG. 1 is a schematic diagram illustrating an exemplary architecture of a transmit-receive coaxial phased array LiDAR chip according to some embodiments of the present disclosure. FIG. 2 is a schematic diagram illustrating an exemplary structure of a single phased array element of a transmit-receive phased array according to some embodiments of the present disclosure.

In some embodiments, as shown in FIG. 1 and FIG. 2, a transmit-receive coaxial phased array LiDAR chip includes a laser transmitter unit 1, a main beam splitter 2, and a transmit-receive phased array 3 which are optically connected in sequence, a balanced detector array 4 optically connected to a receiving output port of the transmit-receive phased array, and a signal processing and control unit 5 electrically connected to the laser transmitter unit 1, the transmit-receive phased array 3, and the balanced detector array 4.

In some embodiments, the laser transmitter unit 1, under the control of the signal processing and control unit 5, generates an optical signal and outputs the optical signal to the main beam splitter 2. The main beam splitter 2 splits the optical signal into N channels of optical signals and outputs the N channels of optical signals to the transmit-receive phased array 3, respectively. The transmit-receive phased array 3, under the control of the signal processing and control unit 5, performs phase modulation on the N channels of optical signals to output N channels of phase-modulated signal light and N channels of phase-modulated reference light. The N channels of phase-modulated signal light are projected to a detection region for scanning by the transmit-receive phased array 3. A scanning deflection angle is (θₓ₀, θ_{y0}), and N is greater than 2. The transmit-receive phased array 3 receives an echo signal reflected by a target in the detection region, performs coherent mixing on the echo signal and N channels of frequency-shifted reference light to generate a beat signal, and outputs the beat signal to the balanced detector array 4. A center direction of a receiving field of view of the transmit-receive phased array 3 is (θₓ₀, θ_{y0}). The balanced detector array 4 converts the beat signal carrying echo signal information into an electrical signal and outputs the electrical signal to the signal processing and control unit 5. The signal processing and control unit 5 processes the electrical signal and determines at least one of three-dimensional depth information or velocity information of the target in the detection region based on a time difference between the optical signal output by the laser emitting unit 1 and the echo signal.

The phase-modulated signal light refers to an optical signal that is split by the main beam splitter 2, phase-modulated by the transmit-receive phased array 3, enters the circulator 33, and is finally emitted by the grating radiation antenna 34 for detecting the target. The phase-modulated reference light refers to an optical signal that is split by the main beam splitter 2, phase-modulated by the transmit-receive phased array 3, retained inside the LiDAR chip, and used for subsequent coherent mixing with the echo signal reflected by the target after frequency shifting.

In some embodiments, the signal processing and control unit 5 may determine the time difference based on a time when the optical signal is emitted and a time when the echo signal is received.

The three-dimensional depth information refers to position information of the target relative to the LiDAR system in a three-dimensional space. The position information may include distances of the target relative to the LiDAR system in a horizontal direction, a vertical direction, and a radial direction. The radial direction refers to a direction of a connection line between the target and the LiDAR system. A direction from the target pointing to the LiDAR system is a positive radial direction. The horizontal direction (i.e., an x direction) and the vertical direction (i.e., a y direction) are perpendicular to each other. A plane formed by the horizontal direction and the vertical direction is perpendicular to the radial direction. That is, with the LiDAR system as an origin, a three-dimensional Cartesian coordinate system may be constructed with axes of the horizontal direction, the vertical direction, and the radial direction.

(θₓ₀, θ_{y0}) refers to a preset direction of the scanning deflection angle preset by the LiDAR system. The LiDAR system achieves multi-angle scanning by changing (θₓ₀, θ_{y0}). θₓ₀ and θ_{y0} are respectively a target azimuth angle of the emitted phase-modulated signal light in the x direction and a target azimuth angle of the emitted phase-modulated signal light in the y direction. In some embodiments, the phase modulator may determine a phase compensation amount for the phase-modulated signal light based on (θₓ₀, θ_{y0}), so that the N channels of phase-modulated signal light emitted by the grating radiation antennas 34 are in phase in the (θₓ₀, θ_{y0}) direction. When the echo signal is received, the echo signals received by the plurality of phased array elements have an identical phase in the (θₓ₀, θ_{y0}) direction.

The velocity information may include a velocity direction of the target and a velocity magnitude of the target.

In some embodiments, the signal processing and control unit may determine a movement distance of the target within the time difference from the three-dimensional depth information. The signal processing and control unit may then determine the velocity information of the target based on the movement distance and the time difference.

In some embodiments, the transmit-receive phased array 3 includes N phased array elements. Each of the N phased array elements is optically connected to an output end of the main beam splitter 2.

In some embodiments, as shown in FIG. 2, each of the N phased array elements includes a phase modulator 31, a 1×2 beam splitter 32, a circulator 33, and a grating radiation antenna 34 which are optically connected in sequence, a frequency shifter 35 connected to another outlet of the 1×2 beam splitter 32, and a 90-degree optical mixer 36 connected to a third port of the circulator 33. An outlet of the frequency shifter 35 is connected to an inlet of the 90-degree optical mixer 36, and the 90-degree optical mixer 36 is optically connected to inlets of the balanced detector array 4.

In some embodiments, the circulator 33 includes a first port 331 optically connected to an output end of the 1×2 beam splitter 32, a second port 332 optically connected to the grating radiation antenna 34, and a third port 333 connected to an input end of the 90-degree optical mixer 36. The N channels of phase-modulated signal light are output to the respective grating radiation antenna 34 through the first port 331 and the second port 332 in sequence. The echo signal enters the 90-degree optical mixer 36 through the grating radiation antenna 34, the second port 332, and the third port 333 in sequence.

According to some embodiments of the present disclosure, the circulator having a plurality of ports is utilized to transmit the phase-modulated signal light and the echo signal, respectively. The circulator cooperates with other optically connected components in the phased array element, such as the phase modulator, the 1×2 beam splitter, the grating radiation antenna, and the 90-degree optical mixer, to construct an optical transmission path. This arrangement ensures that the transmission and reception optical paths of the LiDAR system are physically coaxial while being signal-isolated, laying a structural foundation for implementing the transmit-receive coaxial phased array LiDAR chip.

In some embodiments, the phase modulator 31 is electrically connected to the signal processing and control unit 5. The phase modulator 31, under control of the signal processing and control unit 5, causes the optical signal to have a phase Δφ₀. The N channels of phase-modulated signal light is projected to the detection region for scanning through the N grating radiation antennas 34. The scanning deflection angle is (θₓ₀, θ_{y0}). The phase Δφ₀ causes echo signals received by the N grating radiation antennas 34 in a (θₓ₀, θ_{y0}) direction to superimpose to achieve a maximum value. The maximum value refers to a maximum value of signal intensity.

In some embodiments, a splitting ratio of the 1×2 beam splitter 32 is in a range of 1:1 to 1:99. A frequency shift magnitude of the frequency shifter 35 is in a range of 1-100 MHz. The 90-degree optical mixer 36 is a multimode interference coupler or includes a directional coupler and a phase shifter. The grating radiation antennas 34 are arranged in a one-dimensional or two-dimensional periodic manner. Alternatively, the grating radiation antennas 34 are arranged in a sparse arrangement manner. Counts of the grating radiation antennas in the x, y directions are n1 and n2, respectively, where n1×n2=N. The one-dimensional periodic manner refers to the grating radiation antennas being arranged at equal intervals along a straight line. The two-dimensional periodic manner refers to the grating radiation antennas being arranged at equal intervals along two perpendicular directions (e.g., the x direction and the y direction as shown in FIG. 3).

FIG. 3 is a schematic diagram illustrating an exemplary arrangement of grating radiation antennas according to some embodiments of the present disclosure.

In some embodiments, as shown in FIG. 3, when the grating radiation antennas 34 are arranged with a period Tᵢ, Tᵢ is an arrangement period of the N grating radiation antennas 34 in an i direction (i=x, y). A scanning angle range θᵢ(i=x, y) in the x, y directions is given by formula (1):

$${θ}_{i} = \pm {sin}^{- 1} \frac{λ}{2 {T}_{i}} \qquad ( 1 )$$

where λ is a wavelength of the optical signal emitted by the laser transmitter unit.

According to some embodiments of the present disclosure, the grating radiation antennas are periodically arranged according to the x, y directions of the emitted signal light. The scanning angle range of the LiDAR system is related to the arrangement period and the wavelength of the optical signal emitted by the laser transmitter unit. This facilitates subsequent phase compensation for the grating radiation antennas in a corresponding (θₓ₁, θ_{y1}) direction.

In some embodiments, the laser transmitter unit 1 is a semiconductor laser chip or a fiber laser. The wavelength of the optical signal output by the laser transmitter unit 1 is between a visible light band and a far-infrared band. The optical signal emitted by the laser transmitter unit 1 is a pulsed laser signal used for a time-of-flight ranging manner, or a frequency-modulated continuous-wave laser signal used for a frequency-modulated continuous-wave ranging manner.

In some embodiments, the main beam splitter 2 and the laser transmitter unit 1 are connected through an on-chip waveguide. The main beam splitter 2 is a 1×N beam splitter. A count of array elements of the balanced detector array is N.

In some embodiments, the signal processing and control unit 5 includes an amplifier, a filter, and a processor.

According to some embodiments of the present disclosure, by configuring the laser transmitter unit as the semiconductor laser chip or the fiber laser and connecting the main beam splitter and the laser transmitter unit through the on-chip waveguide, high integration of the transmit-receive coaxial phased array LiDAR chip can be achieved. Setting the wavelength of the optical signal output by the laser transmitter unit to be between the visible light band and the far-infrared band can cover a broad band, which can adapt to different application environments (e.g., short-range detection, long-range detection, and ensuring user eye safety), thereby improving detection performance.

### Embodiment 2

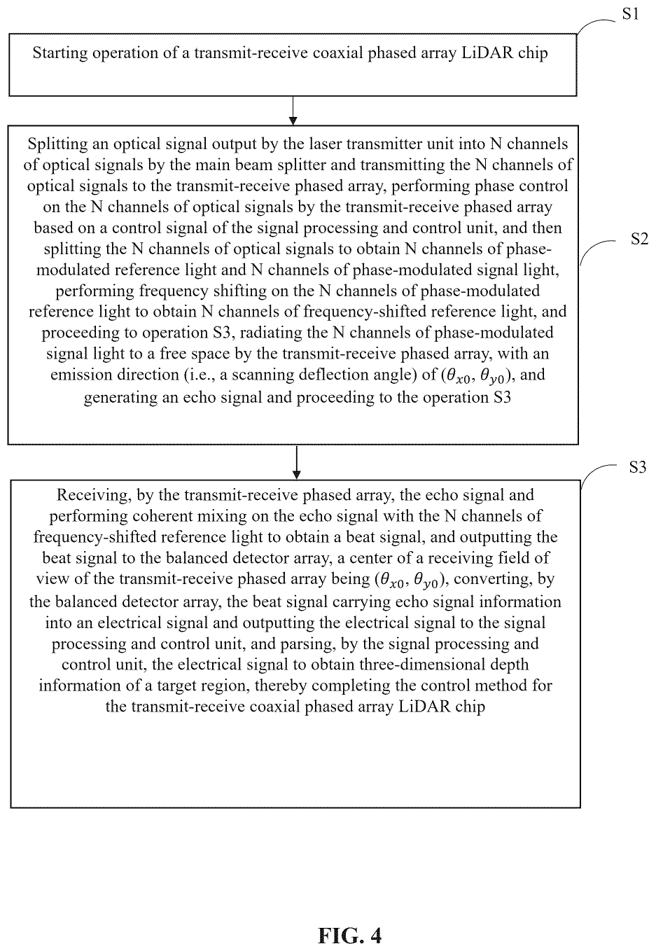

FIG. 4 is a flowchart diagram illustrating an exemplary control method for a transmit-receive coaxial phased array LiDAR chip according to some embodiments of the present disclosure.

As shown in FIG. 4, the control method for the transmit-receive coaxial phased array LiDAR chip includes the following operations:

S1, starting operation of a transmit-receive coaxial phased array LiDAR chip, laser emission proceeding to operation S2, and echo signal reception and processing proceeding to operation S3.

S2, splitting an optical signal output by the laser transmitter unit 1 into N channels of optical signals by the main beam splitter 2 and transmitting the N channels of optical signals to the transmit-receive phased array 3, performing phase control on the N channels of optical signals by the transmit-receive phased array 3 based on a control signal of the signal processing and control unit 5, and then splitting the N channels of optical signals to obtain N channels of phase-modulated reference light and N channels of phase-modulated signal light, performing frequency shifting on the N channels of phase-modulated reference light to obtain N channels of frequency-shifted reference light, and proceeding to operation S3, radiating the N channels of phase-modulated signal light to a free space by the transmit-receive phased array 3, with an emission direction (i.e., a scanning deflection angle) of (θₓ₀, θ_{y0}), and generating an echo signal and proceeding to the operation S3.

The free space refers to an open space region where the signal light is not confined by a waveguide or an optical fiber.

In some embodiments, the transmit-receive phased array 3 includes N phased array elements, each of the N phased array elements includes the phase modulator 31, the beam splitter 32, the circulator 33, and the grating radiation antenna 34 which are optically connected, the frequency shifter 35 connected to another outlet of the beam splitter 32, and the 90-degree optical mixer 36 connected to a third port of the circulator 333. An outlet of the frequency shifter 35 is connected to an inlet of the 90-degree optical mixer 36, and an inlet of the phase modulator 31 is optically connected to N outlets of the main beam splitter 2. The 90-degree optical mixer 36 is optically connected to inlets of the balanced detector array 4.

In some embodiments, in the operation S2, the phase modulator 31 makes (m, n)th channel of reference light have a phase Δφ₀(m, n), thereby becoming (m, n)th phase-modulated reference light.

In some embodiments, in an (m, n)th phased array element, the optical signal first undergoes phase modulation by the phase modulator to set the phase Δφ₀(m, n) to obtain phase-modulated signal light. The phase Δφ₀(m, n) compensates for a phase of an (m, n)th grating radiation antenna 34, so that the N channels of phase-modulated signal light emitted by the N grating radiation antennas 34 are in phase in the (θₓ₀, θ_{y0}) direction. θₓ₀ and θ_{y0} are target azimuth angles of the emitted phase-modulated signal light in the x and y directions, respectively. The (m, n)th grating radiation antenna 34 refers to the grating radiation antenna 34 included in the (m, n)th phased array element.

According to some embodiments of the present disclosure, the phase modulator adjusts the phase of the signal light to the phase Δφ₀(m, n) and compensates the phase of emission by the grating radiation antenna based on the phase Δφ₀(m, n). This ensures that the signal light emitted by the respective grating radiation antennas achieves in-phase superimposition in the target direction (θₓ₀, θ_{y0}). Meanwhile, the received echo signal and the frequency-shifted reference light coherently enhance in the same direction to form a maximum value. Thus, at a structural level, precise scanning of the emitted signal light and adaptive synchronous alignment of the receiving field of view are achieved, thereby significantly improving directivity, sensitivity, and anti-interference capability of the LiDAR system.

In the operation S2, a phase modulation value of the phased array element where the (m, n)th grating radiation antenna 34 is located satisfies formula (2) and an optical path phase delay of the (m, n)th grating radiation antenna 34 in the (θₓ₁, θ_{y1}) direction satisfies formula (3):

$$Δ {ϕ}_{0} ( m , n ) = \frac{2 π}{λ} {mT}_{x} sin {θ}_{x 0} + \frac{2 π}{λ} {nT}_{y} sin {θ}_{y 0} \qquad ( 2 )$$

$$Δ {ϕ}_{1} ( m , n ) = \frac{2 π}{λ} {mT}_{x} sin {θ}_{x 1} + \frac{2 π}{λ} {nT}_{y} sin {θ}_{y 1} \qquad ( 3 )$$

where Δφ₁(m, n) denotes the optical path phase delay of the (m, n)th grating radiation antenna 34 in the (θₓ₁, θ_{y1}) direction. Tₓ denotes an arrangement period of the N grating radiation antennas 34 in an x direction. T_{y} denotes an arrangement period of the N grating radiation antennas 34 in a y direction. θₓ₁ and θ_{y1} denote an actual azimuth angl of the emitted phase-modulated signal light in the x direction and an actual azimuth angle of the emitted phase-modulated signal light in the y direction, respectively. λ is a wavelength of the optical signal emitted by the laser transmitter unit.

In some embodiments, when the optical path phase delay of the (m, n)th grating radiation antenna 34 in the (θₓ₁, θ_{y1}) direction is compensated by an optical path phase difference Δφ₀(m,n): θₓ₁=θₓ₀, and θ_{y1}=θ_{y0}.

(θₓ₁, θ_{y1}) refers to an actual direction in which the phase-modulated signal light is emitted by the grating radiation antenna 34. In some embodiments, by applying corresponding phase compensation value Δφ₀(m, n) to the phase modulators of the respective phased array element, the actual azimuth angle of the emitted signal light equals a preset target azimuth angle. That is, θₓ₁=θₓ₀ and θ_{y1}=θ_{y0}. This means that although physical optical paths from the grating radiation antennas 34 at different positions to a same target are different, compensation phases introduced by the phase modulators of the respective phased array elements exactly cancel optical path phase differences caused by the position differences. Therefore, the phase-modulated signal light emitted by the phased array elements of all the grating radiation antennas 34 are in phase in the (θₓ₀, θ_{y0}) direction. Consequently, maximum coherent superimposition is achieved in the (θₓ₀, θ_{y0}) direction.

S3, receiving, by the transmit-receive phased array 3, the echo signal and performing coherent mixing on the echo signal with the N channels of frequency-shifted reference light to obtain a beat signal, and outputting the beat signal to the balanced detector array 4, a center of a receiving field of view of the transmit-receive phased array 3 being (θₓ₀, θ_{y0}), converting, by the balanced detector array 4, the beat signal carrying echo signal information into an electrical signal and outputting the electrical signal to the signal processing and control unit 5, and parsing, by the signal processing and control unit 5, the electrical signal to obtain three-dimensional depth information of a target region, thereby completing the control method for the transmit-receive coaxial phased array LiDAR chip.

In the operation S3, the beat signal output by superimposing the echo signal and the frequency-shifted reference light has a maximum value in the (θₓ₀, θ_{y0}) direction.

A signal received by the (m, n)th grating radiation antenna 34 is expressed as formula (4):

$$E ( m , n ) = {\int }_{- π / 2}^{π / 2} {\int }_{- π / 2}^{π / 2} G ( {θ}_{x 2} , {θ}_{y 2} ) {E}_{i} ( {θ}_{x 2} , {θ}_{y 2} ) exp ( - i Δ {ϕ}_{2} ( m , n ) ) d {θ}_{x 2} d {θ}_{y 2} \qquad ( 4 )$$

where Eᵢ(θₓ₂, θ_{y2}) denotes a complex amplitude of an electric field of the echo signal in a (θₓ₂, θ_{y2}) direction, G(θₓ₂, θ_{y2}) denotes an element pattern of a single grating radiation antenna 34, G(θₓ₂, θ_{y2}) denotes an electric field coupling strength between a plane wave with a wave vector in the (θₓ₂, θ_{y2}) direction and the (m, n)th grating radiation antenna 34, Δφ₂(m, n) denotes an optical path phase difference of the echo signal in the (θₓ₂, θ_{y2}) direction reaching the (m, n)th grating radiation antenna 34, and Δφ₂(m, n) satisfies formula (5):

$$Δ {ϕ}_{2} ( m , n ) = \frac{2 π}{λ} {mT}_{x} sin {θ}_{x 2} + \frac{2 π}{λ} {nT}_{y} sin {θ}_{y 2} \qquad ( 5 )$$

where λ denotes the wavelength of the optical signal emitted by the laser transmitter unit, Tₓ denotes the arrangement period of the N grating radiation antennas in the x direction, T_{y} denotes the arrangement period of the N grating radiation antennas in the y direction, and θₓ₂ and θ_{y2} denote azimuth angles of the echo signal in the x and y directions, respectively.

In some embodiments, the phase modulator 31 performs phase control on the N phased array elements. A reference light phase modulation value of the phased array element where the (m, n)th grating radiation antenna 34 is located is Δφ₀(m, n). A superimposition sum E_{R} (θₓ₀, θ_{y0}) of received signals of the N phased array elements is expressed as formula (6):

$${E}_{R} ( {θ}_{x 0} , {θ}_{y 0} ) = {\sum }_{m = 0}^{n 1 - 1} {\sum }_{n = 0}^{n 2 - 1} E ( m , n ) exp ( i Δ {ϕ}_{0} ( m , n ) ) = {\sum }_{m = 0}^{n 1 - 1} {\sum }_{n = 0}^{n 2 - 1} {\int }_{- π / 2}^{π / 2} {\int }_{- π / 2}^{π / 2} G ( {θ}_{x 2} , {θ}_{y 2} ) {E}_{i} ( {θ}_{x 2} , {θ}_{y 2} ) exp [ - i ( Δ {ϕ}_{2} - Δ {ϕ}_{0} ) ] d {θ}_{x 2} d {θ}_{y 2} = {\int }_{- π / 2}^{π / 2} {\int }_{- π / 2}^{π / 2} G ( {θ}_{x 2} , {θ}_{y 2} ) {E}_{i} ( {θ}_{x 2} , {θ}_{y 2} ) {\sum }_{m = 0}^{n 1 - 1} {\sum }_{n = 0}^{n 2 - 1} exp [ - i ( Δ {ϕ}_{2} - Δ {ϕ}_{0} ) ] d {θ}_{x 2} d {θ}_{y 2} \qquad ( 6 )$$

where counts of the grating radiation antennas in the x, y directions are n1 and n2, respectively, and n1×n2=N; when Δφ₂=Δφ₀, i.e., θₓ₂=θₓ₀, θ_{y2}=θ_{y0}, a superimposed signal has a maximum value.

(θₓ₂, θ_{y2}) refers to a reflection direction of the echo signal. In some embodiments, the echo signal received by the grating radiation antenna 34 has an optical path phase difference Δφ₂. The phase-modulated reference light in the phased array element, where the grating radiation antenna 34 is located, has been assigned a preset compensation phase Δφ₀ by the phase modulator. Only when the echo signal comes from the (θₓ₀, θ_{y0}) direction, Δφ₂=Δφ₀, i.e., the optical path phase difference Δφ₂ of the echo signal can be completely compensated by the compensation phase Δφ₀. Therefore, echo signals from the (θₓ₀, θ_{y0}) direction received by the N phased array elements achieve in-phase superimposition in a signal superimposition stage, and a synthesized signal E_{R}(θₓ₀, θ_{y0}) reaches a maximum value. For echo signals from other directions, superimposition is incoherent, and the echo signals are effectively suppressed, thereby achieving coaxial transmission and reception of the signal light.

In some embodiments, in the operation S2, a frequency difference between the N channels of frequency-shifted reference light and the N channels of phase-modulated signal light is Δf. In the operation S3, a signal frequency of the beat signal is Δf. A value of Δf may be set by a technician based on experience.

According to some embodiments of the present disclosure, the reference light is frequency-shifted by the frequency shifter to form a stable frequency difference Δf between the frequency-shifted reference light and the emitted phase-modulated signal light. Accordingly, the frequency of the beat signal generated after coherent mixing between the echo signal and the frequency-shifted reference light is also f. The stable and adjustable frequency of the beat signal facilitates improvement of the accuracy and signal-to-noise ratio of signal detection. The stable and adjustable frequency of the beat frequency signal also facilitates frequency-domain analysis and demodulation of the echo signal, thereby extracting at least one of the three-dimensional depth information or the velocity information of the target more accurately.

Through the above operations, the control method for the transmit-receive coaxial phased array LiDAR chip is completed.

### Embodiment 3

As shown in FIG. 1 to FIG. 4, a transmit-receive coaxial phased array LiDAR chip and a control method are provided.

FIG. 1 is a schematic diagram illustrating an exemplary architecture of a transmit-receive coaxial phased array LiDAR chip according to some embodiments of the present disclosure. As shown in FIG. 1, the transmit-receive coaxial phased array LiDAR chip includes: the laser transmitter unit 1, the main beam splitter 2, the transmit-receive phased array 3, the balanced detector array 4, and the signal processing and control unit 5.

The laser transmitter unit 1 is configured to emit an optical signal. In some embodiments, the laser transmitter unit is a semiconductor laser, and the optical signal is a pulsed signal. The main beam splitter 2 is connected to the laser transmitter unit 1 through an on-chip waveguide. The main beam splitter 2 is configured to split the optical signal output by the laser transmitter unit 1 into N channels of optical signals and transmit the N channels of optical signals to the transmit-receive phased array 3. The transmit-receive phased array 3 has N phased array elements. Each of the N phased array elements is connected to an output optical path of the main beam splitter 2. Each of the N phased array elements changes a direction of the optical signal emitted by the laser transmitter unit through phase modulation to complete scanning of a target region. An echo signal reflected by a target is received by the transmit-receive phased array 3, received by the balanced detector array 4, and converted into an electrical signal. The signal processing and control unit 5 may determine a time difference between a transmitted pulse and a received echo pulse and calculate a distance between the target and the LiDAR system. The signal processing and control unit 5 may determine three-dimensional depth information of the target in combination with phase modulation of the emitted optical signal by the transmit-receive phased array.

FIG. 2 is a schematic diagram illustrating an exemplary structure of a single phased array element of a transmit-receive phased array according to some embodiments of the present disclosure. The transmit-receive phased array 3 includes nine identical phased array elements. A single phased array element of the nine phased array elements includes the phase modulator 31, the 1×2 beam splitter 32, the circulator 33, the grating radiation antenna 34, the frequency shifter 35, and the 90-degree optical mixer 36.

The phase modulator 31 performs phase control on the optical signal in the phased array element according to a control signal of the signal processing and control unit 5. The phase modulator 31 is configured to adjust steering of a transmitting field of view and a receiving field of view. The 1×2 beam splitter 32 splits the optical signal into reference light and signal light.

A power ratio of the signal light to the reference light is 4:1. The signal light enters from the first port 331 of the circulator 33 and exits from the second port 332 of the circulator 33, and is then coupled into a free space by the grating radiation antenna 34. The reference light is frequency-shifted by the frequency shifter 35, so that the frequency-shifted reference light and the phase-modulated signal light have a frequency difference Δf=3 MHz. An echo signal reflected by the target is received by the grating radiation antenna 34, enters from the second port 332 of the circulator 33, and exits from the third port 333 of the circulator 33, and enters the 90-degree optical mixer 36 together with the frequency-shifted reference light for coherent mixing to generate a beat signal. A signal frequency of the beat signal is Δf. The circulator is a multi-port device and ensures isolation between the echo signal and the phase-modulated signal light.

FIG. 3 is a schematic diagram illustrating an exemplary arrangement of grating radiation antennas according to some embodiments of the present disclosure. 34 is a grating radiation antenna of a single phased array element. The grating radiation antennas of the nine phased array elements are uniformly arranged. Arrangement periods in the x, y directions are Tₓ and T_{y}, respectively.

When the transmit-receive phased array is used to emit an optical signal, the phase modulator 31 performs phase control on each phased array element, so that a phase modulation value of the phased array element where the (m, n)th grating radiation antenna 34 is located is expressed as formula (2):

$$Δ {ϕ}_{0} ( m , n ) = \frac{2 π}{λ} m {T}_{x} sin {θ}_{x 0} + \frac{2 π}{λ} n {T}_{y} sin {θ}_{y 0} \qquad ( 2 )$$

Then, an optical path phase delay of the echo signal in the (θₓ₁, θ_{y1}) direction of the (m, n)th grating radiation antenna 34 is expressed as formula (3):

$$Δ {ϕ}_{1} ( m , n ) = \frac{2 π}{λ} m {T}_{x} sin {θ}_{x 1} + \frac{2 π}{λ} n {T}_{y} sin {θ}_{y 1} \qquad ( 3 )$$

When the optical path phase delay of the (m, n)th grating radiation antenna is compensated by an optical path phase difference Δφ₀(m, n), i.e., θₓ₁=θₓ₀ and θ_{y1}=θ_{y1}, the phase-modulated signal light emitted by all the grating radiation antennas 34 is in phase in the (θₓ₀, θ_{y0}) direction. Optical waves of the N grating radiation antennas 34 interfere constructively, resulting in very strong light in the (θₓ₀, θ_{y0}) direction. Meanwhile, in other directions, because “all in phase” is not satisfied, light intensity is very small, i.e., the phase-modulated signal light emitted by the phased array element has a maximum value in the (θₓ₀, θ_{y0}) direction. θy controlling the phase modulator 31 of each phased array element of the transmit-receive phased array 3, scanning of the target region with the phase-modulated signal light emitted by the phased array element may be implemented.

In some embodiments, when the phased array element is used for receiving, the echo signal received by the (m, n)th grating radiation antenna 34 may be expressed in an integral form as formula (4):

$$E ( m , n ) = {\int }_{- π / 2}^{π / 2} {\int }_{- π / 2}^{π / 2} G ( {θ}_{x 2} , {θ}_{y 2} ) {E}_{i} ( {θ}_{x 2} , {θ}_{y 2} ) exp ( - i Δ {ϕ}_{2} ( m , n ) ) d {θ}_{x 2} d {θ}_{y 2} \qquad ( 4 )$$

where Eᵢ(θₓ₂, θ_{y2}) denotes a complex amplitude of an electric field of the echo signal in a (θₓ₂, θ_{y2}) direction, G(θₓ₂, θ_{y2}) denotes an element pattern of a single grating radiation antenna 34, representing an electric field coupling strength between a plane wave having a wave vector in the (θₓ₂, θ_{y2}) direction and the (m, n)th grating radiation antenna, wherein the element pattern characterizes radiation (emission) or reception efficiency of a single grating radiation antenna, and Δφ₂(m, n) denotes an optical path phase difference of the echo signal in the (θₓ₂, θ_{y2}) direction reaching the (m, n)th grating radiation antenna 34, expressed as formula (5):

$$Δ {ϕ}_{2} ( m , n ) = \frac{2 π}{λ} m {T}_{x} sin {θ}_{x 2} + \frac{2 π}{λ} n {T}_{y} sin {θ}_{y 2} \qquad ( 5 )$$

Meanwhile, because the phase modulator 31 performs phase control on each phased array element, a phase modulation value of the reference light of the phased array element where the (m, n)th grating radiation antenna 34 is located is Δφ₀(m, n).

A superimposition sum E_{R}(θₓ₀, θ_{y0}) of the received signals of all the phased array elements is expressed as formula (6):

$${E}_{R} ( {θ}_{x 0} , {θ}_{y 0} ) = {\sum }_{m = 0}^{2} {\sum }_{n = 0}^{2} E ( m , n ) exp ( i Δ {ϕ}_{0} ( m , n ) ) = {\sum }_{m = 0}^{2} {\sum }_{n = 0}^{2} {\int }_{- π / 2}^{π / 2} {\int }_{- π / 2}^{π / 2} G ( {θ}_{x 2} , {θ}_{y 2} ) {E}_{i} ( {θ}_{x 2} , {θ}_{y 2} ) exp [ - i ( Δ {ϕ}_{2} - Δ {ϕ}_{0} ) ] {dθ}_{x 2} d {θ}_{y 2} = {\int }_{- π / 2}^{π / 2} {\int }_{- π / 2}^{π / 2} G ( {θ}_{x 2} , {θ}_{y 2} ) {E}_{i} ( {θ}_{x 2} , {θ}_{y 2} ) {\sum }_{m = 0}^{2} {\sum }_{n = 0}^{2} exp [ - i ( Δ {ϕ}_{2} - {Δϕ}_{0} ) ] d {θ}_{x 2} d {θ}_{y 2} \qquad ( 6 )$$

where counts of the grating radiation antennas 34 in the x, y direction are n1 and n2, respectively, and n1×n2=N; according to formula (6), when Δφ₂=Δφ₀, i.e., θₓ₂=θₓ₀, θ_{y2}=θ_{y0}, a superimposed echo signal has a maximum value.

Therefore, the transmit-receive phased array 3 may be regarded as a lensless optical system that rotates according to the optical path phase difference. When the phase modulator 31 sets the phase modulation value of the phased array element where the (m, n)th grating radiation antenna 34 is located to Δφ₀(m, n), a transmission angle of the transmit-receive phased array is (θₓ₀, θ_{y0}), and a center direction of the receiving field of view is also (θₓ₀, θ_{y0}).

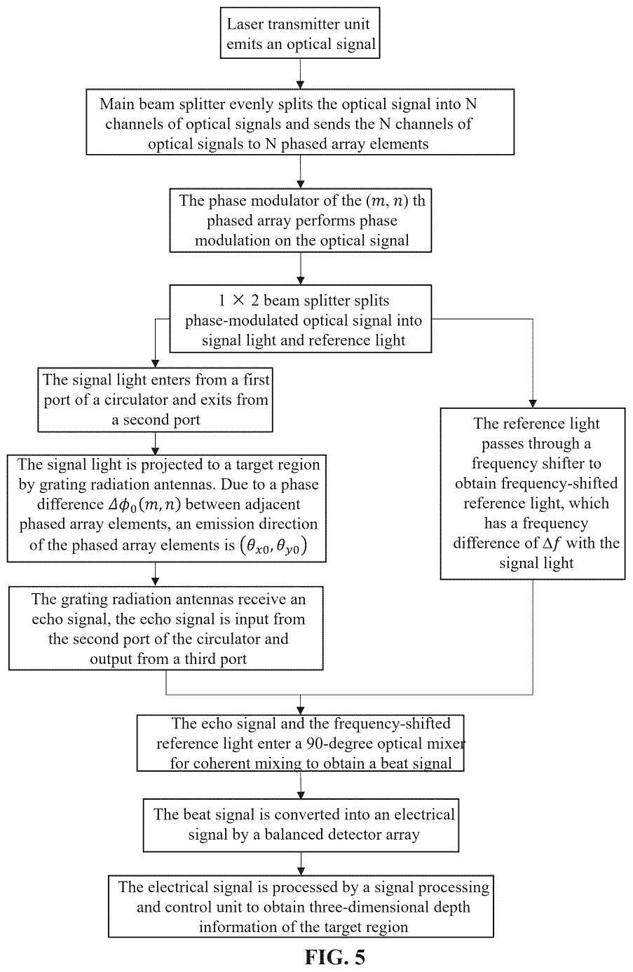

FIG. 5 is a flowchart diagram illustrating an exemplary control method for a transmit-receive coaxial phased array LiDAR chip in Embodiment 3 according to some embodiments of the present disclosure, illustrating a workflow of a transmit-receive phased array LiDAR system of the present embodiment in conjunction with FIG. 4.

The laser transmitter unit 1 emits an optical signal. The optical signal is input to the main beam splitter 2. The main beam splitter 2 evenly splits the optical signal into N channels of optical signals and sends the N channels of optical signals to the transmit-receive phased array 3 having N phased array elements.

In the (m, n)th phased array element, the optical signal first undergoes phase modulation by the phase modulator 31 to set a phase, the phase expressed as formula (2):

$$Δ {ϕ}_{0} ( m , n ) = \frac{2 π}{λ} m {T}_{x} sin {θ}_{x 0} + \frac{2 π}{λ} n {T}_{y} sin {θ}_{y 0} \qquad ( 2 )$$

The optical signal is then split by the 1×2 beam splitter 32 into reference light and signal light to be output.

The signal light is input to the first port 331 of the circulator 33 and output from the second port 332 of the circulator 33. The signal light is diffracted into a free space by the grating radiation antenna 34. Since the (m, n)th phased array element has a set optical path phase difference Δθ₀(m, n), an equiphase surface is formed in the (θₓ₀, θ_{y0}) direction, and output light is emitted in the (θₓ₀, θ_{y0}) direction.

Echo signals of all directions are received by the grating radiation antenna 34, input from the second port 332 of the circulator 33, and output from the third port 333 of the circulator 33.

The reference light passes through the frequency shifter 35 to obtain frequency-shifted reference light. The frequency-shifted reference light has a frequency difference of Δf from the signal light. The frequency-shifted reference light is then input to the 90-degree optical mixer 36. Since the (m, n)th reference light has the phase of Δφ₀(m, n), a final received beat signal has a maximum value in the (θₓ₀ θ_{y0}) direction.

The beat signal is converted into an electrical signal by a balanced detector array 4. The electrical signal is then processed by the signal processing and control unit 5 to obtain three-dimensional depth information of a target region.

In existing technologies, a laser transmitting axis and a telescope receiving axis of a transmit-receive off-axis LiDAR system are not coaxial. Since a receiving optical path has a limited angle of field of view, an echo signal in an off-axis transmit-receive optical path needs to travel a certain distance before entering the angle of the receiving field of view. This results in a large field of view blind spot in the off-axis LiDAR system. The farther apart the transmitting axis and the receiving axis, the larger the field of view blind spot, typically around 4 m.

The present embodiment can achieve transmit-receive coaxial detection. The receiving end and transmitting end can share a same transmit-receive lens. The transmitting field of view and the receiving field of view are coincident without alignment between the transmitting field of view and the receiving field of view. The problem of blind spot caused by incomplete coincidence between the transmitting field of view and the receiving field of view in the transmit-receive off-axis LiDAR system does not exist. Theoretically, only blind spots caused by detector dead time inside the LiDAR system exist, approximately 0.1 m to 2 m.

Compared with direct detection, the present embodiment uses a balanced detector coherent detection scheme. The balanced detector provides an additional gain of P_{ref}/Pᵣ, where P_{ref} is a reference light power and Pᵣ is a received light power. The weaker the received signal, the more pronounced the advantage of balanced detector coherent detection. The coherent detection effect of the balanced detector is related to a splitting ratio. When the splitting ratio is 1:1, the signal-to-noise ratio is typically more than 20 dB higher than that of single-detector detection.

Since the LiDAR system employs the transmit-receive coaxial phased array, the LiDAR system controls the transmitting field of view and the receiving field of view through the transmit-receive coaxial phased array. The receiving field of view of the LiDAR system flexibly steers with the transmitting field of view. A static field of view is small, and a dynamic field of view is large. This is beneficial for reducing stray light and improving the signal-to-noise ratio. Meanwhile, the LiDAR system solves the problems of a large blind spot and difficulty in alignment in conventional LiDAR systems, where problems are caused by an optical phased array being used only for transmission but not for reception, and by transmission and receiving optical paths being non-coaxial. Moreover, the LiDAR system employs a coherent detection scheme, which improves the signal-to-noise ratio. Meanwhile, since key components of the LiDAR system are all based on semiconductor materials, integration of optical components and PCBs is easy to achieve, thereby improving the integration level of the LiDAR system. The LiDAR system has advantages such as a flexible field of view, a high signal-to-noise ratio, easy integration, and low cost.

In some embodiments, for some high-reflection objects (i.e., near-field high-reflection regions) relatively close to the LiDAR system, intensities of reflected echo signals are relatively large. The large intensities easily cause beat signals received by the balanced detector array 4 to enter a saturation state, causing the LiDAR system to enter a temporary blinding state.

In some embodiments, to avoid the blinding state, the signal processing and control unit 5 may perform a pre-scan before the LiDAR system performs a formal scan. Through the pre-scan, the LiDAR system detects positions and velocities of the near-field high-reflection regions in advance, so that the LiDAR system uses a relatively low scanning power to scan the near-field high-reflection regions during the formal scan, thereby avoiding the blinding state caused by saturation of the balanced detector array 4.

In some embodiments, the signal processing and control unit 5 controls the laser emitting unit 1 to perform the pre-scan on a detection region at a first power level. The signal processing and control unit 5 generates an echo intensity distribution map based on an electrical signal output by the balanced detector array 4 during the pre-scan. The signal processing and control unit 5 determines a near-field high-reflection region based on the echo intensity distribution map. In response to a scanning deflection angle of the transmit-receive phased array 3 pointing to the near-field high-reflection region, the signal processing and control unit 5 controls the laser transmitter unit 1 to emit an optical signal at a second power level. The second power level is lower than the first power level.

More descriptions regarding the laser transmitter unit 1, the signal processing and control unit 5, the transmit-receive phased array 3, the balanced detector array 4, the detection region, the electrical signal, and the scanning deflection angle may be found in FIGS. 1-2 and the related descriptions thereof.

The first power level refers to a scanning power used by the laser transmitter unit 1 when performing the pre-scan.

In some embodiments, the first power level may be set by a technician based on experience.

The pre-scan refers to a scan performed before the formal scan. Both the scanning power and scanning time of the pre-scan are lower than the scanning power and scanning time of the formal scan. The formal scan refers to a scan described in the foregoing Embodiments 1-3.

The electrical signal output during the pre-scan refers to an electrical signal converted from the beat signal received during the pre-scan by the balanced detector array 4.

The echo intensity distribution map refers to a map reflecting the intensities of echo signals at different spatial positions.

The spatial position refers to a position of a target relative to the LiDAR system in a two-dimensional plane. The two-dimensional plane may be a plane formed with the LiDAR system as an origin and the horizontal direction and the vertical direction as axes. That is, the spatial position includes a position of the target relative to the LiDAR system in the horizontal direction and a position of the target relative to the LiDAR system in the vertical direction.

In some embodiments, the spatial position may be characterized by the scanning deflection angle (θₓ₀, θ_{y0}). One scanning deflection angle in one laser emission corresponds to one spatial position. An echo signal intensity corresponding to the scanning deflection angle may reflect an echo signal intensity corresponding to the spatial position.

The echo signal intensity refers to an intensity of an optical signal (i.e., the echo signal) reflected by an object during the pre-scan. In some embodiments, the echo signal intensity may be determined based on a beat signal received by the balanced detector array 4 during the pre-scan. For example, echo signal information in the beat signal may be obtained, and then the echo signal intensity may be determined.

In some embodiments, for each scanning deflection angle of the pre-scan, the signal processing and control unit 5 receives an electrical signal during the pre-scan output by a corresponding element of the balanced detector array. The signal processing and control unit 5 performs Fast Fourier Transform (FFT) on the electrical signal to obtain a spectrum of the beat signal of the pre-scan. The signal processing and control unit 5 uses a main peak amplitude of the beat signal of the pre-scan in the spectrum as the echo signal intensity. The echo intensity distribution map may be constructed based on all the scanning deflection angles and corresponding echo signal intensities. The main peak amplitude refers to an amplitude with the highest energy variation amplitude in the spectrum.

The echo signal and the beat signal during the pre-scan are similar to the echo signal and the beat signal during the formal scan. More descriptions regarding the echo signal and the beat signal may be found in FIGS. 1-3 and the related descriptions thereof.

The near-field high-reflection region refers to a region within the detection region that is within a near-distance range of the LiDAR system and has a high echo signal intensity (e.g., a smooth object surface).

In some embodiments, the near-distance range may be set by a technician based on experience. For example, the near-distance range may be within a range of 5 m from the LiDAR system, with the LiDAR system as a center.

The high echo signal intensity refers to an echo signal intensity exceeding a signal intensity threshold. In some embodiments, the signal intensity threshold may be set by a technician based on experience.

In some embodiments, the signal processing and control unit 5 may determine the near-field high-reflection region based on the echo intensity distribution map in various ways.

Merely by way of example, the signal processing and control unit 5 may determine a plurality of spatial positions corresponding to a plurality of echo signal intensities greater than a first preset threshold in the echo intensity distribution map. The signal processing and control unit 5 may determine a region corresponding to a spatial position, among the plurality of spatial positions, where a target distance from the LiDAR system is less than a second preset threshold as the near-field high-reflection region.

In some embodiments, the signal processing and control unit 5 may discretize and grid an angular space formed by all scanning deflection angles detectable by the LiDAR system, such that one scanning deflection angle corresponds to one “cell” in the angular space. In some embodiments, the angular space may be a maximum conical space formed with an emission port of the laser transmitter unit as a vertex and the scanning deflection angles as edges. One “cell” corresponding to one scanning deflection angle may correspond to one conical region. A two-dimensional region of the conical region corresponding to the scanning deflection angle on the two-dimensional plane is the region corresponding to the spatial position.

In some embodiments, one spatial position corresponds to one beat signal (generated by coherent mixing of the echo signal corresponding to the spatial position with the frequency-shifted reference light). The signal processing and control unit 5 may obtain a target distance corresponding to the spatial position based on a correspondence between a signal frequency of the beat signal and the target distance. Merely by way of example, the correspondence may be a calculation formula (7) under a frequency-modulated continuous wave (FMCW) scheme:

$$R = 2 \frac{d f}{dt} c Δ f \qquad ( 7 )$$

where Δf denotes the signal frequency of the beat signal corresponding to the spatial position, R denotes the target distance corresponding to the spatial position,

$$\frac{d f}{dt}$$

denotes a frequency modulation slope, the frequency modulation slope may be set by a technician based on experience or experimental data, and c denotes the speed of light. More descriptions regarding Δf may be found elsewhere in the present disclosure.

In some embodiments, the first preset threshold may be determined based on a saturation signal intensity of the balanced detector array 4. Merely by way of example, the saturation signal intensity may be used as the first preset threshold. The saturation signal intensity refers to a maximum signal intensity that the balanced detector array 4 can receive during normal operation. The saturation signal intensity may be obtained based on factory parameters of the balanced detector array 4.

In some embodiments, the second preset threshold may be set by a technician based on experience.

In some embodiments, the signal processing and control unit 5 may obtain a rate of echo intensity change based on the echo intensity distribution map. In response to the rate of echo intensity change exceeding a third preset threshold, the signal processing and control unit 5 may determine the near-field high-reflection region.

The rate of echo intensity change refers to a rate of change of the echo signal intensity with respect to the scanning deflection angle. The greater the rate of echo intensity change, the more drastic change in the echo signal intensity.

In some embodiments, for one scanning deflection angle, the signal processing and control unit 5 may determine an echo signal intensity corresponding to the scanning deflection angle and an echo signal intensity corresponding to a nearest adjacent scanning deflection angle of the scanning deflection angle in the echo intensity distribution map. The signal processing and control unit 5 may determine a gradient of change between the echo signal intensity corresponding to the scanning deflection angle and the echo signal intensity corresponding to the nearest adjacent scanning deflection angle as the rate of echo intensity change for the scanning deflection angle.

In some embodiments, the nearest adjacent scanning deflection angle of one scanning deflection angle refers to a scanning deflection angle corresponding to a spatial position that is nearest to a spatial position characterized by the scanning deflection angle in the echo intensity distribution map.

In some embodiments, the third preset threshold may be set by a technician based on experience.

In some embodiments, the signal processing and control unit 5 may determine rates of echo intensity change of a plurality of scanning deflection angles (i.e., a plurality of spatial positions) within the detection region. The signal processing and control unit 5 may determine conical regions (i.e., regions corresponding to the spatial positions) corresponding to scanning deflection angles where the rates of echo intensity change exceed the third preset threshold as the near-field high-reflection regions.

According to some embodiments of the present disclosure, by introducing the rate of echo intensity change as an auxiliary judgment indicator, the signal processing and control unit can more sensitively and earlier identify the near-field high-reflection regions (e.g., metal edges, specular reflectors, etc.). Even if an echo signal intensity or a target distance of a region does not fully meet determination conditions, the region can be included in a control range of emission power in advance based on the rate of echo intensity change, which further optimizes a dynamic adjustment strategy for scanning power, enhances adaptability to complex near-field targets, and effectively reduces the risk of saturation or signal distortion of the balanced detector array caused by strong reflections from the near-field high-reflection regions. Therefore, the reliability and safety of the LiDAR system in near-field detection can be improved.

In some embodiments, the signal processing and control unit 5 determines a spectral feature based on the electrical signal output by the balanced detector array 4 during the pre-scan. In response to the spectral feature satisfying a preset condition, the signal processing and control unit 5 identifies a plurality of risk regions and determines the near-field high-reflection region based on the plurality of risk regions.

In some embodiments, each scanning deflection angle may correspond to one spectral feature.

In some embodiments, the signal processing and control unit 5 may perform spectral analysis on the electrical signal output by the balanced detector array 4 during the pre-scan to obtain the spectral feature. The spectral feature corresponding to the scanning deflection angle may include fundamental wave energy, second harmonic energy, third harmonic energy, etc., of the electrical signal corresponding to the scanning deflection angle.

In some embodiments, the preset condition may include that a ratio of the second harmonic energy to the fundamental wave energy or a ratio of the third harmonic energy to the fundamental wave energy exceeds a fourth preset threshold.

In some embodiments, the fourth preset threshold may be set by a technician based on experience.

The risk region refers to a region within the detection region that may cause the balanced detector array 4 to be in a nonlinear response.

The nonlinear response refers to a phenomenon where an energy change of the beat signal received by the balanced detector array 4 no longer increases or decreases linearly.

In some embodiments, the signal processing and control unit 5 may determine a conical region corresponding to a scanning deflection angle where the spectral feature satisfies the preset condition as the risk region.

In some embodiments, the signal processing and control unit 5 may determine the plurality of risk regions as the near-field high-reflection regions.

According to some embodiments of the present disclosure, by performing spectral analysis on the electrical signal output by the balanced detector array during the pre-scan and monitoring changes in harmonic components (e.g., the second harmonic energy and the third harmonic energy) in the spectral feature corresponding to the electrical signal, the signal processing and control unit can identify the risk of nonlinear response of the received beat signal before the balanced detector array is completely saturated. Therefore, the signal processing and control unit can more proactively implement power regulation or protection strategies, further improving reliability and detection accuracy of the LiDAR system in complex dynamic environments.

The second power level refers to a scanning power used for scanning the near-field high-reflection region during the formal scan.

In some embodiments, to avoid saturation of the balanced detector array 4 caused by strong reflection of the signal light from the near-field high-reflection region, the second power level is less than the first power level.

In some embodiments, the second power level may be set by a technician based on experience.

In some embodiments, the signal processing and control unit 5 determines the second power level through a power control model. Input parameters of the power control model include a pre-scan echo power, the scanning deflection angle, and an environmental temperature and humidity. More descriptions regarding the scanning deflection angle may be found elsewhere in the present disclosure.

The power control model refers to a model used to determine the second power level. In some embodiments, the power control model may be a machine learning model. Merely by way of example, the machine learning model may be a convolutional neural network (CNN) or the like.

In some embodiments, an input of the power regulation model may be the pre-scan echo power, the scanning deflection angle, and the environmental temperature and humidity, and an output of the power control model may be the second power level.

The pre-scan echo power refers to a power of the echo signal during the pre-scan.

In some embodiments, the signal processing and control unit 5 may determine the pre-scan echo power corresponding to the scanning deflection angle by analyzing the echo signal information of in the beat signal corresponding to the scanning deflection angle during the pre-scan.

The environmental temperature and humidity refer to a temperature and a humidity of an environment where the LiDAR system is located.

In some embodiments, the environmental temperature and humidity may be obtained through monitoring devices for temperature and humidity (e.g., a temperature sensor and a humidity sensor).

In some embodiments, the power control model may be trained based on a plurality of training samples with labels through various ways (e.g., gradient descent). Merely by way of example, the signal processing and control unit 5 may input the plurality of training samples with the labels into an initial power control model, construct a loss function based on the labels and output results of the initial power control model, and iteratively update parameters of the initial power control model based on the loss function. Training is completed when a preset training condition is satisfied, and a trained power control model is obtained. The preset training condition may be convergence of the loss function, a count of iterations reaching a preset count threshold, etc.

In some embodiments, the training samples may include a sample pre-scan echo power, a sample scanning deflection angle, and a sample environmental temperature and humidity. The labels may include a laser emission power when a spectral feature corresponding to the training sample satisfies the preset condition.

The training samples and the labels may be obtained based on experimental data. For example, in an experimental environment, a plurality of experimental reflection targets of different types (e.g., objects at different distances from the LiDAR system and with different reflectivity) are set. For each of the experimental reflection targets, in the pre-scan, a preset reference power is used for laser emission, and information such as a pre-scan echo signal power, a scanning deflection angle, and an environmental temperature and humidity corresponding to the preset reference power are recorded as the training samples.

In the formal scan, a plurality of preset experimental powers with different magnitudes (e.g., a plurality of preset experimental powers arranged from low to high in magnitude) are used for laser emission. Meanwhile, electrical signals output by the balanced detector array 4 are recorded. During multiple experiments with gradually increasing power, spectral analysis is performed on the electrical signal output in each experiment. A ratio of second harmonic energy to fundamental wave energy or a ratio of third harmonic energy to fundamental wave energy corresponding to each preset experimental power is recorded. When the ratio of the second harmonic energy to the fundamental wave energy or the ratio of the third harmonic energy to the fundamental wave energy exceeds a preset safety threshold (e.g., the fourth preset threshold), the experiment is stopped, and the corresponding preset experimental power is used as the label.

According to some embodiments of the present disclosure, by establishing the power control model based on the pre-scan echo power, the scanning deflection angle, and the environmental temperature and humidity, the laser emission powers used for the near-field high-reflection regions of different types (e.g., different distances or different reflectivity) can be dynamically adjusted. This can effectively avoid saturation and nonlinear distortion of the balanced detector array 4, and can optimize detection performance of the LiDAR system in different environments, further improving adaptability to complex near-field scenarios and measurement reliability.

According to some embodiments of the present disclosure, by performing the pre-scan on the detection region to generate the echo intensity distribution map and dynamically adjusting the laser emission power, the “blinding” phenomenon caused by saturation of the balanced detector array 4 due to the near-field high-reflection region (e.g., car taillight) can be effectively avoided. The dynamic blind spot of the LiDAR system is significantly reduced, and detection reliability and safety in complex near-field environments are improved.

In some embodiments, in a calibration stage, the signal processing and control unit 5 controls the laser transmitter unit 1 to emit an optical signal, collects a first electrical signal output by the balanced detector array 4, and extracts a crosstalk fingerprint from the first electrical signal. In a formal detection stage, the signal processing and control unit 5 collects a second electrical signal output by the balanced detector array 4 and filters out a spectral component corresponding to the crosstalk fingerprint from the second electrical signal.

The calibration stage refers to a stage of performing background calibration before formal detection, to identify inherent internal noise of the LiDAR system (e.g., an optical crosstalk, a circuit background noise, etc).

In some embodiments, the LiDAR system may perform laser emission to a target-free region (e.g., a target-free airspace) or a known low-reflectivity reference target (e.g., an absorbing material) to execute the calibration stage.

The first electrical signal refers to an electrical signal converted from a beat signal received by the balanced detector array 4 in the calibration stage. The first electrical signal includes internal noise signal information of the LiDAR system. The internal noise signal information refers to information related to an internal noise signal of the LiDAR system, such as a frequency of the internal noise signal, an energy magnitude of the internal noise signal, or the like.

More descriptions about the conversion of the beat signal to the electrical signal may be found in FIG. 1 and the related descriptions thereof.

The crosstalk fingerprint refers to an inherent characteristic capable of characterizing internal noise of the LiDAR system.

In some embodiments, the signal processing and control unit 5 may perform FFT on the first electrical signal to determine the spectral feature of the first electrical signal. The signal processing and control unit 5 may analyze the spectral feature of the first electrical signal to determine a spectral component of the internal noise signal. The signal processing and control unit 5 may use the spectral component as the crosstalk fingerprint.

The formal detection stage refers to a stage of performing actual detection on the detection region. In some embodiments, after the calibration stage is completed, the formal detection stage may be entered.

In some embodiments, the formal detection stage may include the pre-scan and the formal scan. More descriptions regarding the pre-scan and the formal scan may be found elsewhere in the present disclosure.

The second electrical signal refers to an electrical signal converted from a beat signal received by the balanced detector array 4 in the formal detection stage. The second electrical signal includes the internal noise signal information of the LiDAR system and echo signal information of the target.

In some embodiments, the signal processing and control unit 5 may perform the fast Fourier transform on the second electrical signal to obtain a spectral feature of the second electrical signal. The signal processing and control unit 5 may filter out the spectral component corresponding to the crosstalk fingerprint from the spectral feature of the second electrical signal. For example, a manner of filtering out the spectral component corresponding to the crosstalk fingerprint may be performing pointwise complex subtraction between the spectral feature of the second electrical signal and the spectral feature of the first electrical signal.

In some embodiments, after the spectral component corresponding to the crosstalk fingerprint is filtered out, the spectral feature of the second electrical signal retains only a spectral component corresponding to the echo signal of the target.

In some embodiments, in the calibration stage, the signal processing and control unit 5 establishes and stores a fingerprint database. The fingerprint database associates different power levels of laser emission with crosstalk fingerprints corresponding to the different power levels. In the formal detection stage, the signal processing and control unit 5 determines a crosstalk fingerprint corresponding to a current power level by querying the fingerprint database, and filters out the crosstalk fingerprint corresponding to the current power level.

The fingerprint database refers to a database including different power levels and corresponding crosstalk fingerprints.

In some embodiments, the fingerprint database may be constructed through historical data or experimental data. Merely by way of example, the signal processing and control unit 5 may emit optical signals with different powers according to a laser emission manner in the calibration stage (e.g., performing laser emission to the target-free region or the known low-reflectivity reference target), and extract corresponding crosstalk fingerprints, respectively. Different laser emission powers and the corresponding crosstalk fingerprints are recorded in a database, and the database is determined as the fingerprint database.

The current power level refers to a power level of laser emitted by the laser transmitter unit in the formal detection stage.

The current power level may be input by a user or set by a technician based on experience.

In some embodiments, in the formal detection stage, the signal processing and control unit 5 determines the crosstalk fingerprint corresponding to the current power level by querying the fingerprint database based on the current power level.

In some embodiments, the signal processing and control unit 5 obtains a second electrical signal corresponding to the current power level output by the balanced detector array 4. The signal processing and control unit 5 determines the spectral feature of the second electrical signal. The signal processing and control unit 5 filters out a spectral component corresponding to the crosstalk fingerprint from the spectral feature.

According to some embodiments of the present disclosure, by establishing the crosstalk fingerprint database dynamically associated with the emission power of the optical signal, a process of filtering out the crosstalk fingerprint can adapt to changes in the emission power of the optical signal. Mismatch of the crosstalk fingerprint caused by adjustment of the emission power is avoided. Therefore, stable and efficient noise suppression effects are maintained across a full power range. Detection accuracy and reliability of the LiDAR system at different power levels are significantly improved.

According to some embodiments of the present disclosure, by extracting the inherent crosstalk fingerprint of the LiDAR system in the calibration stage, and performing frequency-domain identification and filtering of the crosstalk fingerprint in the formal detection stage, fixed background noise caused by internal signal light leakage from components such as the circulator can be effectively suppressed. The signal-to-noise ratio of the received signal of the LiDAR system is significantly improved. Limitations on the sensitivity of the LiDAR system caused by non-ideal devices are overcome.

In some embodiments, the signal processing and control unit 5 generates a three-dimensional point cloud map of the detection region based on three-dimensional depth information of the target. The signal processing and control unit 5 generates a velocity field point cloud map including a radial velocity component of the target based on velocity information of the target and the three-dimensional point cloud map. The signal processing and control unit 5 outputs at least one of the three-dimensional point cloud map or the velocity field point cloud map to a display terminal.

More descriptions regarding the three-dimensional depth information and the velocity information may be found in FIG. 1 and FIG. 2 and the related descriptions thereof.

The three-dimensional point cloud map refers to a map representing three-dimensional spatial position information of a plurality of targets in the detection region. One point in the three-dimensional point cloud map represents the three-dimensional spatial position information of one target. In some embodiments, the three-dimensional spatial position information of the target in the three-dimensional point cloud map may be represented by a three-dimensional coordinate point (a, b, c) in a three-dimensional coordinate system.

In some embodiments, the three-dimensional coordinate system may be any three-dimensional coordinate system, such as a Cartesian coordinate system, a spherical coordinate system, or the like.

In some embodiments, the signal processing and control unit 5 obtains a target distance R and the scanning deflection angle (θₓ₀, θ_{y0}) corresponding to each target. The signal processing and control unit 5 determines the three-dimensional coordinate point corresponding to the target through coordinate transformation. The signal processing and control unit 5 generates the three-dimensional point cloud map based on three-dimensional coordinate points corresponding to all targets.

In some embodiments, the coordinate transformation may be implemented by formula (8):

$$( a , b , c ) = ( R sin ( {θ}_{x 0} ) , R sin ( {θ}_{y 0} ) , R cos ( {θ}_{x 0} sin ( {θ}_{y 0} ) )$$

More descriptions regarding the target distance corresponding to the target may be found elsewhere in the present disclosure.

The radial velocity component refers to a velocity of a target relative to the LiDAR system (e.g., the laser transmitter unit) in a radial direction. The radial direction refers to a direction of a connection line between the target and the LiDAR system.

The velocity field point cloud map refers to a distribution map of radial velocity components of a plurality of targets in the detection region.

In some embodiments, the signal processing and control unit 5 may, on the basis of the three-dimensional point cloud map, attach a radial velocity component of the target corresponding to the three-dimensional coordinate point for each three-dimensional coordinate point (a, b, c), to obtain the velocity field point cloud map. Attachment manners include, but are not limited to, color mapping visualization. For example, the higher the color saturation, the larger the radial velocity component.

In some embodiments, the signal processing and control unit 5 may determine the radial velocity component of the target through velocity decomposition based on the velocity information of the target. More descriptions regarding the velocity information of the target may be found in FIG. 1 and the related descriptions thereof.

In some embodiments, the signal processing and control unit 5 may output at least one of the three-dimensional point cloud map or the velocity field point cloud map to the display terminal for a user to view. In some embodiments, the display terminal includes, but is not limited to, a mobile device, a vehicle-mounted display screen, or the like.

According to some embodiments of the present disclosure, the three-dimensional spatial position and the radial velocity of each target are visually displayed through the three-dimensional point cloud map and the velocity field point cloud map. The spatial geometric structure and motion state of the target in the detection region are clearly visualized. The subsequent target recognition, scenario understanding, and decision analysis for the LiDAR system are greatly facilitated. The perception value and practicality of the LiDAR system in practical applications such as autonomous driving and environmental monitoring are significantly improved.

In some embodiments, the signal processing and control unit 5 is integrated with or communicatively connected to a processor of a mobile vehicle. The processor is configured to receive the velocity field point cloud map; identify a risk object based on the velocity field point cloud map; generate a control command based on the risk object; and control the mobile vehicle to perform avoidance or deceleration based on the control command.

The mobile vehicle refers to a carrier that can carry the LiDAR system and has the capacity of moving, such as a car, an unmanned aerial vehicle (UAV), a robot, or a ship.

The processor may receive and process signals or data from the mobile vehicle and/or the LiDAR system. The processor executes program instructions based on the data, the information, and/or processing results to perform one or more functions described in the present disclosure.

In some embodiments, the processor may be a computer, a user console, a single processor, a processor group, or the like. The processor group may be centralized or distributed. In some embodiments, the processor may be implemented on a cloud platform. Merely by way of example, the cloud platform may include one of a private cloud, a public cloud, a hybrid cloud, or any combination thereof.

In some embodiments, the processor may be integrated into the mobile vehicle or communicatively connected to the mobile vehicle.

The risk object refers to an object that may cause damage to or obstruct the mobile vehicle, such as an obstacle.

In some embodiments, the processor may screen out a plurality of three-dimensional coordinate points in the velocity field point cloud map, wherein a direction of the radial velocity component of each of the plurality of three-dimensional coordinate points points to a positive radial direction and an absolute value of the radial velocity component of each of the plurality of three-dimensional coordinate points exceeds a safety threshold. The processor may perform clustering on a plurality of three-dimensional coordinate points through a clustering algorithm to generate one or more point cloud clusters. One point cloud cluster is determined as one risk object. The clustering manner includes, but is not limited to, Euclidean clustering, DBSCAN clustering, density peaks clustering, etc. More descriptions regarding the positive radial direction may be found in FIG. 1 and the related descriptions thereof.

The safety threshold may be set by a technician based on experience.

The control command refers to a command for controlling the mobile vehicle to perform emergency avoidance. In some embodiments, the control command includes, but is not limited to, commands for steering, braking, stopping, etc.

In some embodiments, the processor may determine the control command based on a relative position and the radial velocity component of the risk object. For example, the processor may generate the control command through a decision tree based on the relative position, a moving velocity, and a predicted trajectory of the risk object, and a self-state of the mobile vehicle. The processor may determine an average value of target distances of a plurality of three-dimensional coordinate points in the point cloud cluster corresponding to the risk object as the relative position of the risk object. The processor may determine an average value of radial velocity components of the plurality of three-dimensional coordinate points in the point cloud cluster corresponding to the risk object as the moving velocity of the risk object. More descriptions regarding the target distance and the radial velocity component may be found elsewhere in the present disclosure.

The self-state of the mobile vehicle refers to an operation parameter of the mobile vehicle. The self-state of the mobile vehicle includes, but is not limited to, a size of the mobile vehicle (obtained based on factory parameters), a moving velocity of the mobile vehicle (obtained by an on-board velocity sensor), self-position information of the mobile vehicle (obtained by an on-board GPS positioning system), etc.

The processor may generate the predicted trajectory of the risk object through a Kalman filter, a Markov model, a Gaussian process regression/Gaussian mixture model, a recurrent neural network (RNN), etc.

The decision tree refers to a structural model for determining the control command.

In some embodiments, the decision tree may be constructed and preset manually or by the processor based on historical data or experimental data. In some embodiments, An input of the decision tree may include the relative position, the moving velocity, and the predicted trajectory of the risk object, and the self-state of the mobile vehicle, and an output of the decision tree may include the control command.

In some embodiments, the processor may control the mobile vehicle to perform avoidance or deceleration based on the control command.

According to some embodiments of the present disclosure, the velocity field point cloud map perceived by the LiDAR system is coupled with the processor of the mobile vehicle. The risk object (e.g., a flying stone and hail) approaching at a high speed in a traveling direction of the mobile vehicle can be identified in real time. The control command for active avoidance or deceleration is generated accordingly. The safety performance and autonomous obstacle avoidance capability of the mobile vehicle in complex or harsh environments are significantly improved.

The foregoing descriptions are merely preferred specific implementations of the present disclosure. However, the protection scope of the present disclosure is not limited thereto. Any person skilled in the art within the technical scope disclosed in the present disclosure may make equivalent replacements or changes according to the technical solutions of the present disclosure and the inventive concept of the present disclosure. All such replacements or changes should fall within the protection scope of the present disclosure.

What is claimed is:

1. A transmit-receive coaxial phased array LiDAR chip, comprising a laser transmitter unit, a main beam splitter, and a transmit-receive phased array which are optically connected in sequence, a balanced detector array optically connected to a receiving output port of the transmit-receive phased array, and a signal processing and control unit electrically connected to the laser transmitter unit, the transmit-receive phased array, and the balanced detector array; wherein
the laser transmitter unit, under the control of the signal processing and control unit, generates an optical signal and outputs the optical signal to the main beam splitter, the main beam splitter splits the optical signal into N channels of optical signals and respectively outputs the N channels of optical signals to the transmit-receive phased array, the transmit-receive phased array, under the control of the signal processing and control unit, performs phase modulation on the N channels of optical signals to output N channels of phase-modulated signal light and N channels of phase-modulated reference light, the N channels of phase-modulated signal light are projected to a detection region for scanning by the transmit-receive phased array, a scanning deflection angle is (θₓ₀, θ_{y0}), N is greater than 2, the transmit-receive phased array receives an echo signal reflected by a target in the detection region, and performs coherent mixing on the echo signal with N channels of frequency-shifted reference light to generate a beat signal, and outputs the beat signal to the balanced detector array, a center direction of a receiving field of view of the transmit-receive phased array is (θₓ₀, θ_{y0}), the balanced detector array converts the beat signal carrying echo signal information into an electrical signal and outputs the electrical signal to the signal processing and control unit, and the signal processing and control unit processes the electrical signal and calculates, based on a time difference between the optical signal output by the laser transmitter unit and the echo signal, at least one of three-dimensional depth information or velocity information of the target in the detection region.

2. The transmit-receive coaxial phased array LiDAR chip according to claim 1, wherein the transmit-receive phased array includes N phased array elements, each of the N phased array elements being optically connected to an output end of the main beam splitter;
each of the N phased array elements includes a phase modulator, a 1×2 beam splitter, a circulator, and a grating radiation antenna which are optically connected in sequence, a frequency shifter connected to another outlet of the 1×2 beam splitter, and a 90-degree optical mixer connected to a third port of the circulator, an outlet of the frequency shifter is connected to an inlet of the 90-degree optical mixer, and the 90-degree optical mixer is optically connected to inlets of the balanced detector array; and
the circulator includes a first port optically connected to an output end of the 1×2 beam splitter, a second port optically connected to the grating radiation antenna, and the third port connected to an input end of the 90-degree optical mixer, the N channels of phase-modulated signal light are output to the grating radiation antenna through the first port and the second port in sequence, and the echo signal enters the 90-degree optical mixer through the grating radiation antenna, the second port, and the third port in sequence.

3. The transmit-receive coaxial phased array LiDAR chip according to claim 2,
wherein the phase modulator is electrically connected to the signal processing and control unit, the phase modulator, under the control of the signal processing and control unit, causes the optical signal to have a phase Δφ₀, the N channels of phase-modulated signal light are projected to the detection region for scanning through N grating radiation antennas, the scanning deflection angle is (θₓ₀, θ_{y0}), and the phase Δφ₀ causes echo signals received by the N grating radiation antennas in a (θₓ₀, θ_{y0}) direction to superimpose to achieve a maximum value.

4. The transmit-receive coaxial phased array LiDAR chip according to claim 2, wherein a splitting ratio of the 1×2 beam splitter is in a range of 1:1-1:99, a frequency shift magnitude of the frequency shifter is in a range of 1-100 MHz, the 90-degree optical mixer is a multimode interference coupler or includes a directional coupler and a phase shifter, grating radiation antennas corresponding to the N phased array elements are arranged in a one-dimensional or two-dimensional periodic manner, or the grating radiation antennas are arranged in a sparse arrangement manner, and counts of the grating radiation antennas in x and y directions are n1 and n2, respectively, n1×n2=N;
when the grating radiating antennas are arranged with a period Tᵢ, a scanning angle range θᵢ(i=x, y) in the x, y direction is as follows:
$${θ}_{i} = \pm {sin}^{- 1} \frac{λ}{2 {T}_{i}}$$
where λ is a wavelength of the optical signal emitted by the laser transmitter unit.

5. The transmit-receive coaxial phased array LiDAR chip according to claim 1, wherein the laser transmitter unit is a semiconductor laser chip or a fiber laser, a wavelength of the optical signal output by the laser transmitter unit is between a visible light band and a far-infrared band, the optical signal emitted by the laser transmitter unit is a pulsed laser signal used for a time-of-flight ranging manner, or a frequency-modulated continuous-wave laser signal used for a frequency-modulated continuous-wave ranging manner;
the main beam splitter and the laser transmitter unit are connected through an on-chip waveguide, the main beam splitter is a 1×N beam splitter; and a count of array elements of the balanced detector array is N; and
the signal processing and control unit includes an amplifier, a filter, and a processor.

6. The transmit-receive coaxial phased array LiDAR chip according to claim 1, wherein the signal processing and control unit is configured to:
control the laser transmitter unit to perform a pre-scan on the detection region at a first power level;
generate an echo intensity distribution map based on an electrical signal output by the balanced detector array during the pre-scan;
determine a near-field high-reflection region based on the echo intensity distribution map; and
in response to the scanning deflection angle of the transmit-receive phased array pointing to the near-field high-reflection region, control the laser transmitter unit to emit the optical signal at a second power level; wherein the second power level is lower than the first power level.

7. The transmit-receive coaxial phased array LiDAR chip according to claim 6, wherein the signal processing and control unit is further configured to:
obtain a rate of echo intensity change based on the echo intensity distribution map; and
in response to the rate of echo intensity change exceeding a third preset threshold, determine the near-field high-reflection region.

8. The transmit-receive coaxial phased array LiDAR chip according to claim 6, wherein the signal processing and control unit is further configured to:
determine a spectral feature based on the electrical signal output by the balanced detector array during the pre-scan; and
in response to the spectral feature satisfying a preset condition, identify a plurality of risk regions, and determine the near-field high-reflection region based on the plurality of risk regions.

9. The transmit-receive coaxial phased array LiDAR chip according to claim 6, wherein the signal processing and control unit is further configured to:
determine the second power level through a power control model; wherein input parameters of the power control model include a pre-scan echo power, the scanning deflection angle, and an environmental temperature and humidity.

10. The transmit-receive coaxial phased array LiDAR chip according to claim 1, wherein the signal processing and control unit is further configured to:
in a calibration stage, control the laser transmitter unit to emit the optical signal, collect a first electrical signal output by the balanced detector array, and extract a crosstalk fingerprint from the first electrical signal; and
in a formal detection stage, collect a second electrical signal output by the balanced detector array, and filter out a spectral component corresponding to the crosstalk fingerprint from the second electrical signal.

11. The transmit-receive coaxial phased array LiDAR chip according to claim 10, wherein the signal processing and control unit is further configured to:
in the calibration stage, establish and store a fingerprint database, the fingerprint database associating different power levels of laser emission with crosstalk fingerprints corresponding to the different power levels; and
in the formal detection stage, determine a crosstalk fingerprint corresponding to a current power level by querying the fingerprint database based on a current power level, and filter out the crosstalk fingerprint corresponding to the current power level.

12. The transmit-receive coaxial phased array LiDAR chip according to claim 11, wherein the signal processing and control unit is further configured to:
generate a three-dimensional point cloud map of the detection region based on the three-dimensional depth information of the target;
generate a velocity field point cloud map including a radial velocity component of the target based on the velocity information of the target and the three-dimensional point cloud map; and
output at least one of the three-dimensional point cloud map or the velocity field point cloud map to a display terminal.

13. The transmit-receive coaxial phased array LiDAR chip according to claim 12, wherein the signal processing and control unit is integrated with or communicatively connected to a processor of a mobile vehicle; and the processor is configured to:
receive the velocity field point cloud map;
identify a risk object based on the velocity field point cloud map; and
generate a control command based on the risk object, and control the mobile vehicle to perform avoidance or deceleration based on the control command.

14. A control method for a transmit-receive coaxial phased array LiDAR chip, comprising:
S1, starting operation of the transmit-receive coaxial phased array LiDAR chip, laser emission proceeding to operation S2, and echo signal reception and processing proceeding to operation S3;
S2, splitting an optical signal output by a laser transmitter unit into N channels of optical signals by a main beam splitter and transmitting the N channels of optical signals to a transmit-receive phased array, performing phase control on the N channels of optical signals by the transmit-receive phased array based on a control signal of a signal processing and control unit, and then splitting the N channels of optical signals to obtain N channels of phase-modulated reference light and N channels of phase-modulated signal light, performing frequency shifting on the N channels of phase-modulated reference light to obtain N channels of frequency-shifted reference light, and proceeding to the operation S3, radiating the N channels of phase-modulated signal light to a free space by the transmit-receive phased array with an emission direction of (θₓ₀, θ_{y0}), and generating an echo signal and proceeding to the operation S3; and
S3, receiving, by the transmit-receive phased array, the echo signal and performing coherent mixing on the echo signal with the N channels of frequency-shifted reference light to obtain a beat signal, and outputting the beat signal to a balanced detector array, a center of a receiving field of view of the transmit-receive phased array being (θₓ₀, θ_{y0}), converting, by the balanced detector array, the beat signal carrying echo signal information into an electrical signal and outputting the electrical signal to the signal processing and control unit, and parsing, by the signal processing and control unit, the electrical signal to obtain three-dimensional depth information of a target region, thereby completing the control method for the transmit-receive coaxial phased array LiDAR chip.

15. The control method according to claim 14, wherein in the operation S2, the transmit-receive phased array includes N phased array elements, each of the N phased array elements includes a phase modulator, a beam splitter, a circulator, and a grating radiation antenna which are optically connected, a frequency shifter connected to another outlet of the beam splitter, and a 90-degree optical mixer connected to a third port of the circulator, an outlet of the frequency shifter is connected to an inlet of the 90-degree optical mixer, an inlet of the phase modulator is optically connected to N outlets of the main beam splitter, the 90-degree optical mixer is optically connected to inlets of the balanced detector array, and in an (m, n)th phased array element, the optical signal first undergoes phase modulation by the phase modulator to set a phase Δφ₀(m, n) to obtain phase-modulated signal light, the phase Δφ₀(m, n) compensates for a phase of an (m, n)th grating radiation antenna, so that the N channels of phase-modulated signal light emitted by N grating radiation antennas are in phase in a (θₓ₀, θ_{y0}) direction, θₓ₀, θ_{y0} being target azimuth angles of emitted phase-modulated signal light in x and y directions, respectively;
in the operation S2, the phase modulator makes an (m, n)th channel of reference light have the phase Δφ₀(m, n); and
in the operation S3, the beat signal output by superimposing the echo signal and the N channels of frequency-shifted reference light has a maximum value in the (θₓ₀, θ_{y0}) direction.

16. The control method according to claim 15, wherein:
in the operation S2,
$$Δ {ϕ}_{0} ( m , n ) = \frac{2 π}{λ} m {T}_{x} sin {θ}_{x 0} + \frac{2 π}{λ} n {T}_{y} sin {θ}_{y 0} ;$$
$$Δ {ϕ}_{1} ( m , n ) = \frac{2 π}{λ} m {T}_{x} sin {θ}_{x 1} + \frac{2 π}{λ} n {T}_{y} sin {θ}_{y 1} ;$$
where Δφ₀ (m, n) denotes an optical path phase delay of the (m, n)th grating radiation antenna in a (θₓ₁, θ_{y1}) direction, Tₓ denotes an arrangement period of the N grating radiation antennas in the x direction, T_{y} denotes an arrangement period of the N grating radiation antennas in the y direction, θₓ₁ and θ_{y1} denote actual azimuth angles of the emitted phase-modulated signal light in the x and y directions, respectively, and X, denotes a wavelength of the optical signal emitted by the laser transmitter unit;
when the optical path phase delay of the (m, n)th grating radiation antenna in the (θₓ₁, θ_{y1}) direction is compensated by an optical path phase difference Δφ₀(m, n):
$${θ}_{x 1} = {θ}_{x 0} , {θ}_{y 1} = {θ}_{y 0} .$$

17. The control method according to claim 15, wherein in the operation S3, a signal received by the (m, n)th grating radiation antenna is as follows:
$$E ( m , n ) = {\int }_{- π / 2}^{π / 2} {\int }_{- π / 2}^{π / 2} G ( {θ}_{x 2} , {θ}_{y 2} ) {E}_{i} ( {θ}_{x 2} , {θ}_{y 2} ) exp ( - i {Δϕ}_{2} ( m , n ) ) d {θ}_{x 2} d {θ}_{y 2} ;$$
where Eᵢ(θₓ₂, θ_{y2}) denotes a complex amplitude of an electric field of the echo signal in a (θₓ₂, θ_{y2}) direction, G(θₓ₂, θ_{y2}) denotes an element pattern of a single grating radiation antenna, representing an electric field coupling strength between a plane wave having a wave vector in the (θₓ₂, θ_{y2}) direction and the (m, n)th grating radiation antenna, and Δφ₂(m, n) denotes an optical path phase difference of the echo signal in the (θₓ₂, θ_{y2}) direction reaching the (m, n)th grating radiation antenna:
$$Δ {ϕ}_{2} ( m , n ) = \frac{2 π}{λ} m {T}_{x} sin {θ}_{x 2} + \frac{2 π}{λ} n {T}_{y} sin {θ}_{y 2} ;$$
where λ denotes the wavelength of the optical signal emitted by the laser transmitter unit, Tₓ denotes the arrangement period of the N grating radiation antennas in the x direction, T_{y} denotes the arrangement period of the N grating radiation antennas in the y direction; θₓ₂ and θ_{y2} denote azimuth angles of the echo signal in the x and y directions, respectively; the phase modulator performs phase control on the N phased array elements, a reference light phase modulation value of a phased array element where the (m, n)th grating radiation antenna is located is Δφ₀(m, n), and a superimposition sum of received signals of the N phased array elements is:
$${E}_{R} ( {θ}_{x 0} , {θ}_{y 0} ) = {\sum }_{m = 0}^{n 1 - 1} {\sum }_{n = 0}^{n 2 - 1} E ( m , n ) exp ( i Δ {ϕ}_{0} ( m , n ) ) = {\sum }_{m = 0}^{n 1 - 1} {\sum }_{n = 0}^{n 2 - 1} {\int }_{- π / 2}^{π / 2} {\int }_{- π / 2}^{π / 2} G ( {θ}_{x 2} , {θ}_{y 2} ) {E}_{i} ( {θ}_{x 2} , {θ}_{y 2} ) exp [ - i ( Δ {ϕ}_{2} - Δ {ϕ}_{0} ) ] d {θ}_{x 2} d {θ}_{y 2} = {\int }_{- π / 2}^{π / 2} {\int }_{- π / 2}^{π / 2} G ( {θ}_{x 2} , {θ}_{y 2} ) {E}_{i} ( {θ}_{x 2} , {θ}_{y 2} ) {\sum }_{m = 0}^{n 1 - 1} {\sum }_{n = 0}^{n 2 - 1} exp [ - i ( Δ {ϕ}_{2} - {Δϕ}_{0} ) ] d {θ}_{x 2} d {θ}_{y 2} ;$$
where counts of the grating radiation antennas in the x, y directions are n1 and n2, respectively, and n1×n2=N; when Δφ₂=Δφ₀, θₓ₂=θₓ₀, θ_{y2}=θ_{y0}, a superimposed signal has the maximum value.

18. The control method according to claim 14, wherein: in the operation S2, a frequency difference between the N channels of frequency-shifted reference light and the N channels of phase-modulated signal light is Δf; and in the operation S3, a signal frequency of the beat signal is Δf.
